(19) United States
(12) Patent Application Publication
(10) Pub. No.: US 2024/0131452 A1
(43) Pub. Date: Apr. 25, 2024

(54) DEVICE AND METHOD FOR ENCASING A FILTER UNIT AND/OR SEPARATION UNIT

(71) Applicant: NEUFILTER GMBH, Gronau (DE)

(72) Inventor: Jens NEUMANN

(21) Appl. No.: 18/278,392

(22) PCT Filed: Mar. 1, 2022
(86) PCT No.: PCT/EP2022/055040

§ 371 Date: Aug. 27, 2023

(30) Foreign Application Priority Data
Mar. 12, 2021 (DE) 10 2021 202 415.7
May 30, 2021 (DE) 10 2021 205 544.3

(51) Int. Cl. B01D 25/02; B01D 27/08

(52) U.S. Cl. CPC B01D 25/02; B01D 27/08; B01D 2201/302

(57) ABSTRACT

The invention relates to a device (10) for encasing a filter unit and/or separation unit (22), wherein the filter unit and/or separation unit (22) and/is movable within the device (10) and easily removable from said device (10), and a used filter unit and/or separation unit (22) can be replaced just as easily with a new filter unit and/or separation unit (22).

### BACKGROUND OF THE INVENTION

### 1. Field of the Invention

The invention proposed here relates to the technical field of separating particles that are entrained in an air stream (raw gas stream), in particular separating paint or lacquer particles entrained in a so-called paint mist (paint mist separation).

### 2. Description of Related Art

Devices for this purpose are already known, for example in the form of the filter module described in EP 2 532 409 B.

In particular, the disposal of used filter modules is quite costly and time-consuming. A used filter module, due to the particles (paint and/or lacquer particles) received thereby and deposited there, is moist, at least in part, and in the moist state the filter module, which is often formed from cardboard or a comparable material, loses at least some of its stability. In addition, personnel charged with the disposal of used filter modules come into contact with particles deposited there. This requires, at least at times, protective clothing in the form of gloves and the like.

### SUMMARY OF THE INVENTION

The object of the proposed invention is to facilitate the use of a filter unit and/or separation unit, occasionally referred to only as a filter unit for short, without waiving further general validity. The filter unit comprises at least one filter module and/or separation module, likewise occasionally referred to only as a filter module for short, and multiple filter modules, preferably in a stacked configuration.

The object described above is achieved according to the invention by means of a device for encasing—for at least partially encasing—a filter unit and/or separation unit (filter unit) comprising at least one filter module and/or separation module (filter module).

The or each filter module intended for separating particles that are entrained in an air stream (raw gas stream) is an air filter module and/or paint mist separation module, in any case not a filter module through which a liquid flows through, and correspondingly, the filter unit and/or separation unit (filter unit) are/is then an air filter unit and/or paint mist separator unit. An air filter unit filters an air stream (raw gas stream) and retains at least a portion of the particles entrained therein. A paint mist separator unit brings about a separation of the particles entrained by an air stream (raw gas stream) at at least one surface of the paint mist separator unit, and thus likewise retains at least a portion of the particles entrained therein. The filtering or the separation brings about a considerable reduction of particles, entrained in an air stream (raw gas stream), on a so-called clean air side (the clean air side is the downstream side, based on the flow direction of the raw gas stream) compared to an upstream—raw gas side, inflow side—quantity of particles. For this reason, a filter module and/or separation module, i.e., a device which in this sense has a filtering or separating effect or both a filtering and a separating effect, come(s) into consideration. This is referred to below in summary form as a filter module for short. Any mention of a filter module is at the same time understood to mean the general term “filter module and/or separation module,” as well as the specific term “filter module and/or paint mist separation module.” The same applies for the term “filter unit.” Here as well, any mention of a filter unit is understood to mean the general term “filter unit and/or separation unit” as well as the specific term “filter unit and/or paint mist separator unit.”

The device for encasing (encasing device) comprises at least one first, front wall element and one second, rear wall element. These two wall elements enclose the filter unit on opposite sides, and are intended and configured to enclose the filter unit on opposite sides. This enclosure of the filter unit by means of the two wall elements is the encasing of the filter unit, in any case, an at least partial encasing of the filter unit. The front wall element covers an input side, and the rear wall element covers an output side, of the filter unit. In a configuration enclosing (encasing, at least partially encasing) the filter unit, the two wall elements are detachably connectable to one another, and for encasing/at least partially encasing the filter unit are detachably connectable to one another and/or are connected to the filter unit. In the joined-together state, the two wall elements sealingly rest against the filter unit, and are intended and configured to sealingly rest against the filter unit in the joined-together state. A sealing contact is provided when no, or at least essentially no, air of an air stream that is guided through the filter unit during use of the device escapes at the contact points between the wall element and the filter unit.

In the following discussion, the encasing of the filter unit and the in any case partial encasing of the filter unit are referred to in summary form as “encasing” for short. An at least partial encasing is always to be construed.

The advantage of the device according to the invention is that the particular filter unit may, so to speak, be placed or pushed between the two wall elements of the device, or placed or pushed in front of the rear wall element, then covered by means of the front wall element, and is then ultimately also situated between the two wall elements. The filter unit may comprise a plurality of filter modules, so that during a work operation they may be placed between the two wall elements; of course, however, during a work operation multiple filter modules, included by a filter unit, between the wall elements may likewise be removed when they are used up in the process of paint mist separation and they have reached or exceeded their so-called service life.

In the proposed device, the encasing of the particular filter unit is achieved in a particularly simple manner, in that in a configuration enclosing the filter unit, the two wall elements are detachably connectable to one another and/or detachably connectable to the filter unit, and for encasing the filter unit, are detachably connected to one another and/or to the filter unit. To remove a filter unit from the device, i.e., to remove a filter unit previously enclosed by the wall elements of the device, this connection is released at least to the extent that the connection does not impede removal of the filter unit. Removing the filter unit is at least possible when the connection of the wall elements to one another and/or to the filter unit is completely released. A new, fresh filter unit is placed between the two wall elements, which are then connected to one another and/or to the filter unit. In the state of connection to one another and/or to the filter unit, the wall elements sealingly rest against the filter unit, thus providing the option of leading an air stream, loaded with particles and guided by means of the wall elements, through the filter unit and its at least one filter module. The two wall elements particularly preferably function as an input-side (inflow-side; upstream) air guide element and an output-side (outflow-side; downstream)) air guide element—based on the position of the filter unit in a flow path of the air stream—directly in front of and directly behind the filter unit, respectively.

In a method for using such a device, or a device having individual or multiple properties described below, a used filter unit is removed from the device by releasing the connection between the two wall elements and removing the filter unit between the two wall elements, and placing a new, fresh filter unit in the device by placing the new filter unit between the two wall elements and subsequently connecting the two wall elements to one another.

To avoid unnecessary repetitions, for the further description, features and details that are described in conjunction with the stated method for using such a device for encasing a filter unit naturally apply, also in conjunction with and with regard to the device for encasing a filter unit which is configured for carrying out the method, and vice versa. Accordingly, the method may also be refined by use of individual or multiple method features that relate to method steps that may be carried out using the device, and the device may correspondingly also be refined by means that allow the method to be carried out as intended. Consequently, features and details that are described in conjunction with the method for using a device for encasing a filter unit and possible embodiments naturally apply, also in conjunction with and with regard to the device used for carrying out the method and vice versa in each case, so that with regard to the disclosure, reciprocal reference always is or may be made to the individual aspects of the proposed invention.

Advantageous embodiments of the invention are the subject matter of the subclaims. Back-references that are used within the claims refer to the further development of the subject matter of the referenced claim via the features of the respective dependent claim. They are not to be construed as a waiver of the attainment of independent subject matter protection for the features or feature combinations of a dependent claim. Furthermore, with regard to an interpretation of the claims and of the description, in the event of a more precise specification of a feature in a dependent claim, it is to be assumed that there is no such limitation in the respective preceding claims or in a more general embodiment of the method according to the invention/the device according to the invention. Accordingly, any reference in the description to aspects of dependent claims is expressly to be construed, without specific reference, as a description of optional features.

In one advantageous embodiment, it is provided that the two wall elements enclose the filter unit on opposite sides and spaced apart from one another, and that the wall elements are intended and configured to enclose the filter unit on opposite sides and spaced apart from one another. It is not necessary for the filter unit to be enclosed on all sides by means of the wall elements. Encasing by means of wall elements that are spaced apart, i.e., not touching one another, is sufficient. Even for spaced-apart wall elements, each individual wall element may be effective in coupling the filter unit to a flow path for a raw gas stream from a particular facility to the surroundings (from the facility, through the filter unit, and finally into the surroundings).

An inner part that is placeable in each wall element is preferably provided. Each inner part is advantageously made of the same material as the at least one filter module included in the filter unit, for example cardboard, in particular corrugated cardboard, or the like. Each inner part is designed in such a way that it covers or at least essentially covers the inner surface of the particular wall element. The inner part thus protects the inner surface of the particular wall element from paint particles that would otherwise adhere there. During a replacement of the filter unit, the inner parts previously placed in the wall elements may also be replaced with new inner parts.

The two wall elements of the device are advantageously designed in such a way that, together with the filter unit that is enclosed by the wall elements, and except for an air inlet into the device and an air outlet out of the device, they form a unit that is encapsulated on all sides. For this purpose, the dimensions (width and height) of the wall elements are coordinated with the dimensions (width and height) of the filter unit. With a dimension that is coordinated with the width and the height of a side face of the filter unit, the particular wall element completely covers this side face. Dimensions that are coordinated in this sense are a width and height that correspond or at least essentially correspond to the width and height of the filter unit. The side faces of the filter unit covered by one wall element in each case are the side face with the inflow opening of the or each filter module included in the filter unit, and the side face with the outflow opening of the or each filter module included in the filter unit. The stated openings in a respective filter module (inflow opening, outflow opening) are the openings intended for an air stream that is loaded with particles (paint mist) to enter into the particular filter module, and for the air stream that is freed or at least essentially freed of such particles to exit from the filter module.

It is preferably provided that the rear wall element has the air outlet as an opening (cutout) in one of its surfaces, in particular in its major surface. For example, an air guide element for a separation stage following downstream and/or a filter element following downstream may then be or become connected to the air outlet. Likewise, such a separation stage or such a filter element may be or become directly connected to the air outlet. The connection may be achieved by detachable connectability to the wall element and/or to the air outlet situated there. Alternatively, the connection may be a permanent connection to the wall element and/or to the air outlet, for example an adhesive connection, a riveted connection, or the like. The wall element particularly preferably has the air outlet in its major surface, i.e., in the surface situated in front of the side face of the filter unit with the at least one outflow opening at that location. This means that the air outlet in the wall element directly follows the or each outflow opening of the filter unit in the flow direction (flow direction through the filter unit and the at least one filter module located there). No, or at least essentially no, deflection of the air stream downstream from the filter unit is then necessary on the way to the air outlet.

In one advantageous embodiment of the device according to the invention, it is provided that the front wall element, due to its shape, forms the air inlet. In this regard it is provided, for example, that the front wall element is a molded part that is bent along its vertical axis (in the direction of the dimension “height”) in the manner of a U profile, and that the front wall element, by means of the edges at its upper end, namely, the base and the two legs of the U profile, together with the adjoining surface section of the filter unit forms the air inlet.

The device as a whole may then be placed beneath a spray booth or the like. The paint mist to be separated develops at this location during painting. Due to positive pressure generated upstream from the device or negative pressure generated downstream from the device, the air loaded with particles (the raw gas stream) is discharged into the device via the air inlet, and then guided through the device and the filter unit located there, and subsequently to the surroundings.

The claims filed with the present patent application are proposed formulations without prejudice to the attainment of further patent protection. Since in particular the features of the dependent claims, with regard to the prior art on the date of priority, may form separate, independent inventions, the applicant reserves the right to make these or even further feature combinations, heretofore disclosed only in the description and/or drawings, the subject matter of independent claims or declarations of division. Moreover, the features of the dependent claims may also include separate inventions that are independent from the subject matter of the respective referenced claims.

One exemplary embodiment of the invention is explained in greater detail below with reference to the drawings. Corresponding subject matter or elements is/are provided with the same reference numerals in all figures.

The exemplary embodiment is not to be construed as limiting to the invention. Rather, within the scope of the present disclosure, supplements and modifications are also possible, in particular those that are apparent to those skilled in the art with regard to achieving the object of the invention, for example by combining or modifying individual features or method steps that are described in the general or specific portion of the description and contained in the claims and/or the drawings, and that by use of combinable features result in new subject matter or new method steps or method step sequences.

### BRIEF DESCRIPTION OF THE DRAWINGS

FIG. 1 shows a painting or coating facility that includes a device of the type proposed here,

FIG. 2 shows a device of the type proposed here,

FIGS. 3 and 4 show the device according to FIG. 2 from different directions, and

FIGS. 5 and 6 each show a wall element of the device according to FIG. 2.

### DETAILED DESCRIPTION OF ILLUSTRATED EMBODIMENTS

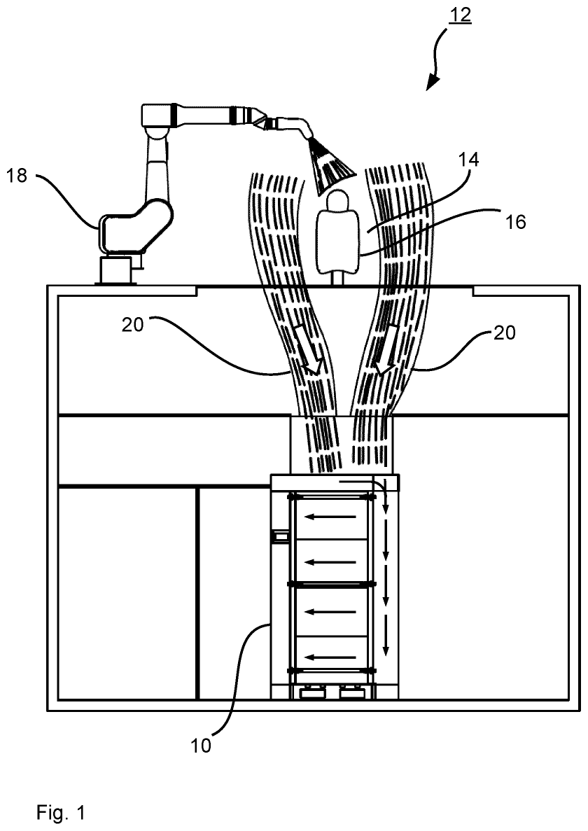

The illustration in FIG. 1 shows a device 10 of the type proposed here. The device 10 is shown within a painting or coating facility 12 that is illustrated in cross section and schematically depicted in a greatly simplified manner. Such a facility 12 is described in EP 2 822 701 A1, for example.

The facility 12, in a manner basically known per se, includes an area that is generally referred to as a spray booth 14. The coating or painting of objects 16 (painting part; painting parts), referred to below in summary form as “painting” for short, takes place at that location, and the object 16 to be painted or the objects 16 to be painted (at least one object) is/are correspondingly situated at that location. The painting takes place by use of painting devices that are basically known per se, for example in the form of painting robots 18.

In the facility 12 shown, paint mist 20 that develops during painting reaches an area below the spray booth 14, and from there passes to the device 10 proposed here, for example due to a positive pressure upstream from the device 10 or a negative pressure downstream from the device 10. The air stream through the device 10, resulting from the positive or negative pressure, is the air stream (raw gas stream) that is loaded with paint particles or the like. In the illustration in FIG. 1, the block arrows in the paint mist 20, above the device 10, and the simple arrows in the region of the device 10 illustrate the direction of the raw gas stream. The shown position of the device 10 below the spray booth 14 is not mandatory, and expressly represents only one option. The device 10 is specifically adapted for this position. This specific, but basically optional, adaptation is explained in greater detail below.

A plurality of the devices 10 proposed here is optionally placed along a longitudinal axis of the facility 12. The devices 10 are movable transversely with respect to the longitudinal axis of the facility 12, for example on a roller conveyor or the like that is part of the facility 12, or by means of a transport device in the form of a lift truck or the like that is intended for this purpose. In the situation shown as an example, the placement of a plurality of devices 10 along the longitudinal axis of the facility 12 is based on the design of the facility 12 and the fact that the objects to be painted in the facility 12 are moved through the facility 12 along their longitudinal direction. For some other type of facility 12, other orientations of a plurality of devices 10, for example transverse to a longitudinal axis, are possible, in which case the direction in which a device 10 is movable also changes correspondingly.

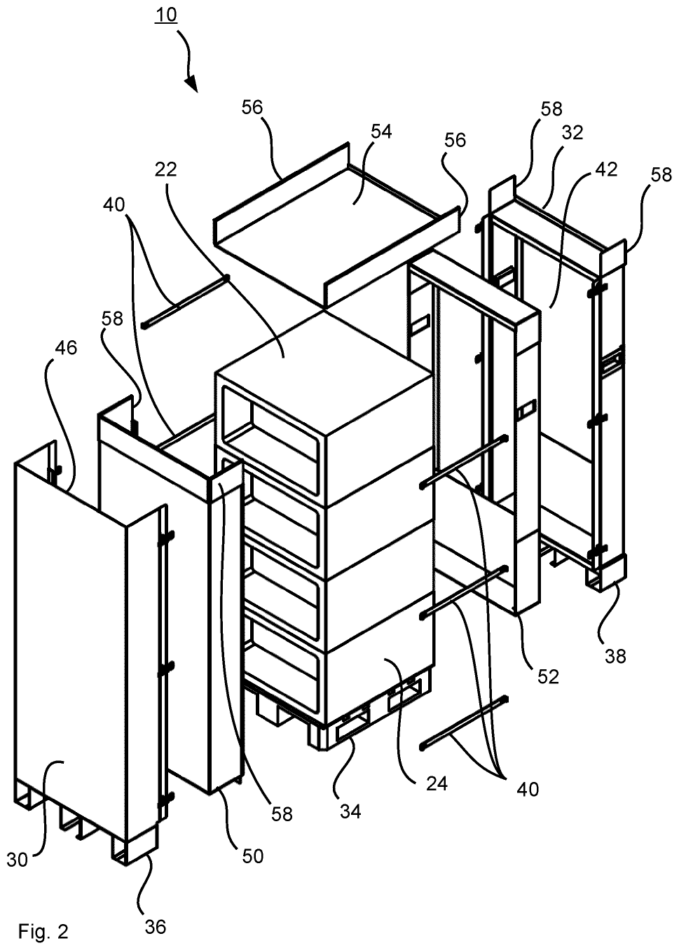

The illustration in FIG. 2 shows, in a schematically simplified form and in an exploded illustration, an example of one embodiment of the device 10 proposed here. The device 10 is intended and configured for encasing a cuboidal, i.e., in any case not merely flat, filter unit and/or separation unit 22 (air filter unit and/or paint mist separator unit), referred to as a filter unit 22 for short. The filter unit 22 includes at least one filter module and/or separation module 24, referred to as a filter module 24 for short. A multilayer paper filter module according to EP 2 532 409 B1, for example, comes into consideration as a filter module 24 or as a component of a filter module 24. In the embodiment shown, the filter unit 22 includes four filter modules 24, the filter modules 24 being stacked one on top of the other, resulting in a tower-like arrangement of the filter modules 24. In such a grouped arrangement (at least two filter modules 24 one on top of the other, in particular exactly two, three, four, five, six, or more filter modules 24 one on top of the other), the filter modules 24 are preferably connected to one another, for example via strapping by means of customary strapping bands, known per se.

A filter module 24, in particular each filter module 24 included in the filter unit 22, comprises a combination of a separation device and at least one pre-separation device. For example, a multilayer paper in a three-dimensional, multiply turned-over arrangement as described in EP 2 532 409 B1 comes into consideration as a separation device. For example, at least one of the devices identified and described as filter units in DE 10 2014 003 608 A comes into consideration as a pre-separation device. A filter module 24, in particular each filter module 24 included in the filter unit 22, particularly preferably comprises the combination of a separation device and at least one pre-separation device in a shared housing that encloses the separation device and the at least one pre-separation device, in particular a housing made of a lightweight material, for example cardboard, corrugated cardboard, or the like. With such a shared housing, there is no need for a seal between a pre-separation stage and a separation stage following in the flow direction.

For encasing (or at least partially encasing) the filter unit 22, the device 10 includes a first and a second wall element 30, 32. The wall elements 30, 32 are molded metal parts, for example, in particular molded sheet metal parts. Other materials, for example plastic, in particular wall elements 30, 32 as molded parts made of a rigid plastic, are likewise conceivable.

In order to make a better distinction, the two wall elements 30, 32 are sometimes also referred to as a front wall element 30 and a rear wall element 32. The position information contained in this designation refers to the air stream through the device 10 and its filter unit 22 during operation. The front wall element 30 is upstream from the filter unit 22 (in front of the filter unit 22) relative to this air stream, and the rear wall element 32 is downstream from the filter unit 22 (behind the filter unit 22) relative to this air stream. In the embodiment shown as an example, the wall elements 30, 32 enclose the filter unit and/or separation unit 22, but are spaced apart from one another, i.e., do not touch. Alternatively, wall elements 30, 32 that directly contact one another are also possible for encasing the filter unit 22.

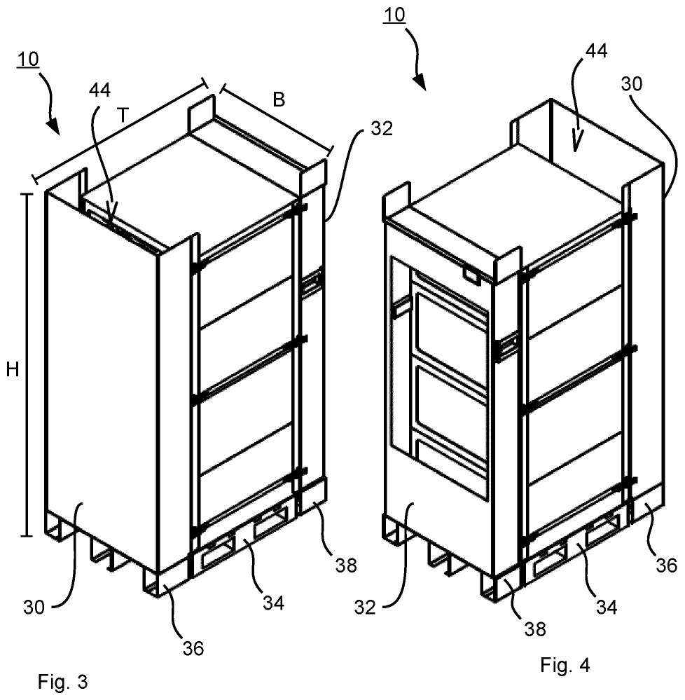

The illustrations in FIGS. 3 and 4 show the device 10 according to FIG. 2 in the operational state. The two wall elements 30, 32 are in contact with the filter unit 22, and are connected to one another for encasing (or at least partially encasing) the filter unit 22.

The front wall element 30 is apparent in the illustration in FIG. 3. The rear wall element 32 is apparent in the illustration in FIG. 4. In the illustration in FIG. 3, the width, the height, and the depth of the device 10 are denoted by reference symbols B, H, and T, respectively. Reference is made to these dimensions in different ways in the present description, and the illustration is intended to show the particular direction in which these dimensions are measured in each case.

The filter unit 22 is situated on a transport element, for example a pallet 34 or the like. The two wall elements 30, 32 in a lower area have a base structure 36, 38, respectively, that is in flush alignment with the particular transport element, and that with its surface adjoins the transport element or the filter unit 22 in an area directly above the transport element. A design in alignment with the pallet 34, situated below the filter unit 22, is shown. As a result of this aligned configuration of the base structure 36, 38, the fork of an appropriate transport device, in particular the fork of a lift truck or the like, may be pushed from the front wall element 30, beneath the filter unit 22, and to the rear wall element 32. In this way, the device 10 as a whole and its important components, namely, the front wall element 30, the filter unit 22, and the rear wall element 32, may be lifted and moved. The movement then takes place, at least initially, in the direction of an axis that extends from the front wall element 30, through the filter unit 22, to the rear wall element 32, namely, an axis that is perpendicular to the surface of the front wall element 30. In principle, a movement of the device 10 as a whole or at least of the filter unit 22 in a direction transverse to this axis is also possible. The fork of a transport device of the above-described type is then pushed transversely with respect to this axis, beneath or into the transport element below the filter unit 22, for example beneath the pallet 34 or into the pallet 34. The filter unit 22 may then be lifted and moved by itself.

The filter unit 22 is preferably connected to a particular transport element, for example a pallet 34 or the like. Strapping comes into consideration for the connection. The strapping advantageously connects a plurality of filter modules 24 included in the filter unit 22 to one another and to the particular transport element. The filter unit 22 and the transport element thus become a unit that is movable together. Strapping that surrounds the transport element firmly presses all filter modules 24 included in the filter unit 22 against one another. This achieves sufficient sealing of the filter modules 24 with respect to one another. The sealing is at least sufficient such that the air stream loaded with particles cannot flow through cracks between the filter modules 24 during use of the filter unit 22. Strapping that surrounds the transport element also firmly presses all filter modules 24 included in the filter unit 22 against the transport element, and thus allows problem-free transport of a (new or used) filter unit 22 by means of the transport element. Such a combination or a comparable combination of the filter unit 22 with a transport element in each case, for example a pallet 34 or the like, also has the advantage that a filter unit 22 may be delivered to a place of use in a directly usable state, and a plurality of filter units 22 may likewise be delivered to a place of use in a directly usable state.

The dimensions of a particular transport element are coordinated with the width B and depth T of a filter unit 22 (the surface area of a transport element corresponds or at least essentially corresponds to the width B and depth T of a filter unit 22). Thus, and by use of the device 10 as a whole, this results in a further advantage of the approach proposed here: The wall elements 30, 32 need be delivered only once to the place of use. The surface area of a device 10 that includes the wall elements 30, 32 and a filter unit 22 encased thereby is in any case larger than the surface area of an individual filter unit 22 (on its respective transport element). In one specific application (the following dimensions are expressly by way of example only), the surface area of a usable device 10 is 120 cm×80 cm, while the surface area of a usable filter unit 22 is 80 cm×80 cm. Regardless of the additional weight of a usable device 10 compared to a usable filter unit 22, with truck loading in a container or the like, in any case more usable filter units 22 than usable devices 10 may be transported due to the smaller surface area requirements. For a delivery of a filter unit 22 on a particular transport element, a usable device 10 may be produced quickly and easily, using at least one pair of wall elements 30, 32 at the place of use. This results in a considerable cost reduction in the area of transport costs. With a surface area of 80 cm×80 cm, a filter unit 22 placed on a particular transport element, for example a pallet 34 or the like, also fits the grid dimensions of a truck loading bed or a container particularly well. Optimal use is thus made of the space available for transport.

The wall elements 30, 32 of the device 10 are connected to one another to obtain a configuration as shown in the illustrations in FIGS. 3 and 4 (operationally ready device 10). For an operationally ready device 10, the two wall elements 30, 32 are connected to one another. Connecting elements in the form of lateral tension bars 40, belts, bands, or the like are preferably provided for connecting the wall elements 30, 32 (for detachably connecting the wall elements 30, 32). These connecting elements, by means of at least one tension lock (at least a one-sided tension lock; alternatively, a two-sided tension lock) engage in recesses in the wall elements 30, 32 intended for this purpose. By tightening of the tension locks, the wall elements 30, 32 are moved toward one another, and are thereby firmly pressed against the surface of the cuboidal filter unit 22 facing the particular wall element 30, 32. In this way, the device 10 is formed into an encapsulated unit, and the cuboidal filter unit 22 is enclosed by the wall elements 30, 32 (encased between the wall elements 30, 32).

For spaced-apart wall elements 30, 32, these wall elements continue to be spaced apart even after such a connection; i.e., they do not touch one another. Threaded rods, by means of which a proper connection of the two wall elements 30, 32 and the encasing of the filter unit 22 are likewise possible in a manner basically known per se, are an alternative to tension bars 40, belts, or bands.

In the embodiment shown, the rear wall element 32 in its major surface has an opening in the form of an in particular rectangular cutout. The opening functions as an outflow opening of the device 10, and is referred to as an air outlet 42 to distinguish it from the outflow opening of the or each filter module 24. The front wall element 30, due to its shape, together with the adjoining surface of the filter unit 22 forms the air inlet 44 into the device 10. For this purpose, the front wall element 30, as shown, has a U shape (shape like a U profile), for example, along its vertical axis and not including the base structure 36. The upper edge 46 of the front wall element 30, i.e., the base of the U profile and the two laterally adjoining legs, and the surface of the filter unit 22 facing the front wall element 30 border the air inlet 44. This results in a rectangular air inlet 44 into the device 10. In connection with the air inlet 44, the front wall element 30 functions as a channel (air guide channel, air guide element) in front of the filter unit 22, i.e., in front of all filter modules 24 included in the filter unit 22. The rear wall element 32 likewise functions as a channel (air guide channel, air guide element) in connection with the filter unit 22.

The device 10 is coupled to a particular facility 12 by means of the air inlet 44, and a further filter stage and/or separation stage may be directly or indirectly coupled to the air outlet 42 farther downstream from the device 10. The coupling of the device 10 to a particular facility 12 takes place in a manner basically known per se, in particular by means of a coupling unit that is part of the facility 12, not part of the device 10. For example, the facility is coupleable to the device 10, or the device 10 is coupleable to the coupling unit. The dimensions (width and depth) of the coupling unit and of the device 10 are coordinated with one another, so that the coupling unit covers the top side of the device 10, in particular the air inlet 44 thereof.

During use of the device 10, paint mist passes from the particular facility 12 via the air inlet 44 and into the device 10. From there, the air stream loaded with particles flows into and through the filter unit 22 and the at least one filter module 24 included in the filter unit, and the air stream that is freed or at least essentially freed of particles leaves the device 10 through the air outlet 42. The particles entrained in the paint are separated essentially in the filter unit 22, namely, the at least one filter module 24 included in the filter unit. After such use of the device 10 for a certain period of time, the surfaces of the at least one filter module 24 intended for the separation become full, and the separated material reduces the volumetric flow that is possible through the filter unit 22. The filter unit 22 has then reached its so-called service life and must be replaced. In particular, this is greatly simplified by use of the device 10 proposed here.

For a plurality of devices 10 (group of devices 10) arranged, as described at the outset, along an axis of a particular facility 12, the replacement of a filter unit 22 in each case takes place as follows, for example: The device 10 together with the filter unit 22 to be replaced is lifted and moved by means of a transport device intended for this purpose (for example, a lift truck or the like). For this purpose, a fork or the like of the transport device is pushed beneath the base structures 36, 38 of the wall elements 30, 32 and beneath the transport element below the filter unit 22. The device 10 is then withdrawn from the group of devices 10, transversely with respect to the axis of the facility 12, by means of the transport device, and in particular at least far enough so that the filter unit 22 between the wall elements 30, 32 of the device 10 becomes accessible.

There are basically two options for replacing the filter unit 22: Either the front wall element 30 is detached and moved or placed to the side, and the filter unit 22 is detached from the rear wall element 32 in the direction of the previous movement of the device 10, and disposed of. Or, the filter unit 22 is removed transversely with respect to the direction of the previous movement of the device 10 between the wall elements 30, 32. In both variants, the connection of the wall elements 30, 32 is released beforehand in order to remove the filter unit 22. The release of the connection of the wall elements 30, 32 may mean removal of all connecting elements provided for this purpose (tension bars 40 or the like), or also only removal of the connecting elements on one side of the device 10.

Alternatively, for replacing a filter unit 22 in each case, there is the option for the release of the connection of the wall elements 30, 32 to take place while still in the facility 12. Threaded rods or the like then preferably function as connecting elements. The rear wall element 32 then remains in the facility 12 during replacement of a filter unit 22. For the replacement, the remainder of the device 10—without the rear wall element 32 detached therefrom—is either, as described above, withdrawn from the group of devices 10, transversely with respect to the axis of the facility 12, by means of the transport device until the filter unit 22 becomes accessible, or the front wall element 30 is removed so that the filter unit 22 becomes accessible.

For disposal of the filter unit 22, after detachment from the encasing between the wall elements 30, 32, the filter unit is lifted and moved by means of a particular transport device, using the transport element situated below the filter unit 22. A new filter unit 22 is lifted and moved in a similar manner, and is placed either in front of the rear wall element 32 or between the two wall elements 30, 32. The two wall elements 30, 32, optionally after placement of the front wall element 30 in front of the filter unit 22, are subsequently reconnected to one another (detachably connected to one another), and the device 10 is placed in its original position by means of the particular transport device.

In the embodiment shown, the device 10 includes, in a manner that is basically optional, a first, front inner part 50 and/or a second, rear inner part 52. The front inner part 50 is intended for placement in the front wall element 30 and for masking the inner side or at least a portion of the inner side of the front wall element 30, and is placed in the front wall element 30 and detachably fixed there, preferably by means of an adhesive, in particular by means of an adhesive glue. The rear inner part 52 is intended for placement in the rear wall element 32 and for masking the inner side or at least a portion of the inner side of the rear wall element 32, and is placed in the rear wall element 32 and detachably fixed there, preferably by means of an adhesive, in particular by means of an adhesive glue. The dimensions of the respective inner part or inner parts 50, 52, which in this regard may even be referred to in each case as masking, for this purpose are coordinated with the corresponding dimensions of the respective wall element 30, 32 or wall elements 30, 32. In the state in which it/they is/are placed in the particular wall element 30, 32, the inner part 50, 52 or the inner parts 50, 52 cover(s) the inner surface of the respective wall element 30, 32, or at least essentially cover(s) the inner surface of the respective wall element 30, 32. The inner parts 50, 52 thus protect the inner surface of the wall elements 30, 32 from an accumulation of paint mist particles that collect there when an inner part 50, 52 is present. The inner part 50, 52 or the inner parts 50, 52 is/are preferably made of the structure-giving material of the at least one filter module 24, for example cardboard or corrugated cardboard. The inner part 50, 52 or the inner parts 50, 52 may be disposed of separately, and, for example, during replacement of the filter unit 22 is/are disposed of and replaced by new inner parts 50, 52. When exactly one inner part 50, 52 is used, it preferably functions as a front inner part 50 that is intended for placement in the front wall element 30, as described above, since the front wall element 30 is upstream from the filter unit 22 and thus comes into contact with the air stream loaded with particles. The use of a replaceable inner part 50/the masking with a replaceable inner part 50 is particularly meaningful at that location.

In the embodiment shown, the device 10 also includes a basically optional cover part 54. This cover part is intended for mounting on the top side of the filter unit 22, and fulfills essentially the same function as the inner parts 50, 52, i.e., protects the other parts of the device 10 from an accumulation of paint particles that collect at a cover part 54 when it is present. The cover part 54 is also preferably made of the structure-giving material of the at least one filter module 24, for example cardboard or corrugated cardboard. The cover part 54 may also be disposed of separately, and, for example, during replacement of the filter unit 22 is disposed of and replaced by a new cover part 54. The cover part 54 also preferably covers an upper area of each of the wall elements 30, 32, and thus prevents contamination at that location by paint particles which would otherwise accumulate there.

As shown, the cover part 54 includes basically optional lateral flaps 56. In the illustration in FIG. 2, these flaps are shown bent upwardly. During mounting of the cover part 54, these flaps 56 are preferably laid against vertical edge segments 58 (fin-like edge segments 58) of the wall elements 30, 32, and bent over an upper edge of these edge segments 58 on their outer side, and optionally adhesively bonded there. These flaps 56 are bordered by the coupling unit in a forceps-like manner, and serve to seal off with respect to the coupling unit. Folding the flaps 56 over these edge segments 58 serves to stabilize the flaps 56, so that they are in an upright and expected position when gripped in a forceps-like manner by the coupling unit or by portions thereof.

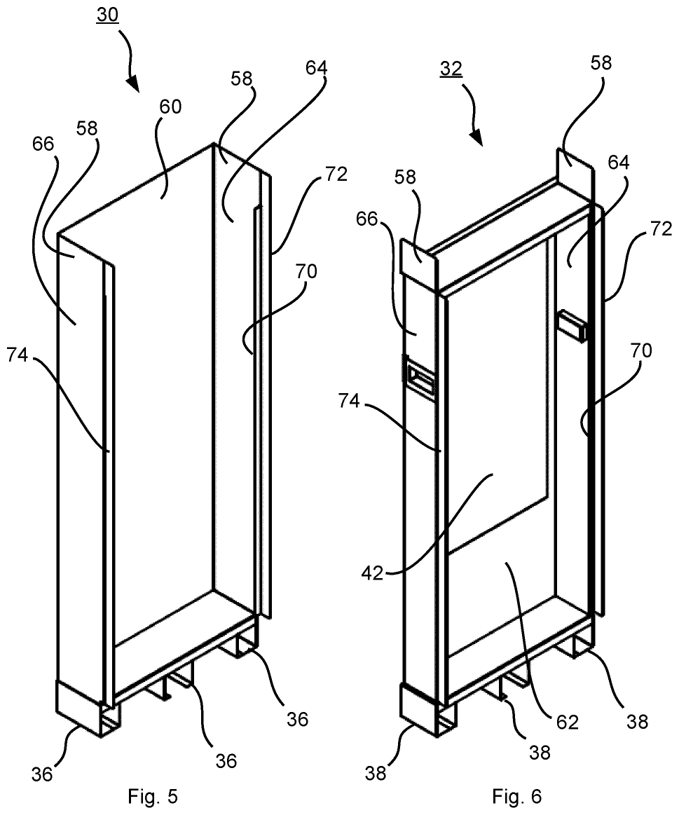

The illustrations in FIGS. 5 and 6 each show a wall element 30, 32; namely, FIG. 5 shows the front wall element 30 and FIG. 6 shows the rear wall element 32, each with a view of the inner side facing the filter unit 22 for an operationally ready device 10 (without the inner parts 50, 52, which are placed there in the case of an operationally ready device 10).

The illustrations in FIGS. 5 and 6 in particular show the frame-like shape of the wall elements 30, 32. Each large surface 60, 62, possibly broken through by the air outlet 42 (rear wall element 32; FIG. 6), is adjoined by edge-side side sections 64, 66 at least along the vertical axis of the wall element 30, 32. These side sections are angled by 90° or at least essentially 90° with respect to the respective major surface, and in the joined-together state the wall elements 30, 32 together with these side sections 64, 66 adjoin the filter unit 22. The side sections 64, 66 at or in their inner surface have stops that function as spacers (in the illustrations, only visible for one side section 64 in each case). In the embodiment shown, a projection 70 on the inner surface of the side sections 64, 66 functions as a stop. The projection 70 is, for example, the one leg of a bracket that is connected to the respective side section 64, 66 by riveting, welding, adhesive bonding, or the like. In addition, for handling the wall elements 30, 32, optionally provided grip recesses or the like may function as a stop or as an additional stop.

In the embodiment shown, along their vertical axis the side sections 64, 66 end in flap-like end faces 72, 74. In one preferred embodiment, these end faces adjoin the side sections 64, 66 in the plane of the side sections, slightly inclined with respect to the plane of the side sections 64, 66, and spread outwardly, and are intended for lateral contact with the filter unit 22. Such an expressly only slight spreading, a slight funnel-shaped spreading, so to speak, facilitates the mounting of a particular wall element 30, 32 on a filter unit 22. By means of these end faces 72, 74, the wall elements 30, 32 rest not only against the side faces of the filter unit 22 having the at least one inflow opening and outflow opening, but also, at least in part, against the other side walls of the filter element 22 (even for end faces 72, 74 that are slightly spread outwardly); this results in an at least partial overlap of the wall elements 30, 32 with the filter unit 22.

Joints between each of the wall elements 30, 32 and the filter unit 22 are preferably taped, using adhesive tape, for example, in particular using adhesive tape in the form of industrial adhesive tape, duct tape, gaffer tape, masking tape, or the like. This is one option for detachably connecting a wall element 30, 32 in each case to a filter unit 22. When such joints are taped, in the case of wall elements 30, 32 with flap-like end faces 72, 74, approximately one-half of the region of these end faces 72, 74 and the adjoining surface of the filter unit 22 is taped over in each case. The end faces 72, 74 then also function on one side as a substrate for a particular section of adhesive tape.

A seal (not shown) is advantageously provided between each wall element 30, 32 and the filter unit 22. This seal may be situated on the particular wall element 30, 32 on the edge side, and when the wall element 30, 32 is mounted, for example rests against the projection 70 that functions there as a stop. In the same way or additionally, a seal may be situated at the wall element 30, 32, for example at the projection 70 that functions there as a stop. As a further alternative or in addition, a seal (at the wall element 30, 32 and/or at the filter unit 22) may be situated in the area in which the wall element 30, 32 and the filter unit 22 overlap when the wall element 30, 32 is mounted, for example on the inner side of the flap-like end faces 72, 74.

Although the proposed invention has been illustrated and described in detail with reference to the exemplary embodiment, the invention is not limited to the disclosed example, and other variations may be derived therefrom by those skilled in the art without departing from the scope of protection of the invention.

Individual key aspects of the description filed here may thus be briefly summarized as follows: A device (10) for encasing a filter unit (22) is provided. The filter unit (22) is movable within the device (10) and by means of the device (10), and is easily removable from the device (10). A used filter unit (22) can be just as easily replaced with a new filter unit (22).

### LIST OF REFERENCE NUMERALS

10 device, device for encasing a filter unit
12 facility, painting facility
14 spray booth
16 painting part
18 painting robot
20 paint mist
22 filter unit, filter unit and/or separation unit
24 filter module, filter module and/or separation module
26, 28 (unassigned)
30 wall element, front wall element
32 wall element, rear wall element
34 pallet
36 base structure (at the front wall element)
38 base structure (at the rear wall element)
40 tension bar
42 air outlet
44 air inlet
46 edge (upper edge of the front wall element)
48 (unassigned)
50 inner part, front inner part
52 inner part, rear inner part
54 cover part
56 (lateral) flap (at the cover part)
58 edge segment (at the top of the wall element)
60 major surface (of the front wall element)
62 major surface (of the rear wall element)
64, 66 side section (of a wall element)
68 (unassigned)
70 projection (in the side face of a wall element)
72, 74 flap-like end face (of a wall element)

1. A device (10) for encasing an air filter unit and/or paint mist separator unit (22) that comprise(s) at least one air filter module and/or paint mist separation module (24) and includes at least one first, front wall element and one second, rear wall element (30, 32),
wherein the wall elements (30, 32) enclose the air filter unit and/or paint mist separator unit (22) on opposite sides,
wherein the front wall element (30) covers an input side, and the rear wall element (32) covers an output side, of the air filter unit and/or paint mist separator unit (22),
wherein in a configuration enclosing the air filter unit and/or paint mist separator unit (22), the two wall elements (30, 32) are detachably connectable to one another and/or to the air filter unit and/or paint mist separator unit (22), and
wherein the two wall elements (30, 32) in the joined-together state sealingly rest against the air filter unit and/or paint mist separator unit (22).

2. The device (10) according to claim 1,
wherein the wall elements (30, 32) enclose the air filter unit and/or paint mist separator unit (22) on opposite sides and spaced apart from one another.

3. The device (10) according to claim 1,
wherein the two wall elements (30, 32) function as air guide elements upstream and downstream. respectively, from the air filter unit and/or paint mist separator unit (22).

4. The device (10) according to claim 1,
including an inner part (50, 52) that is placeable in each wall element (30, 32).

5. The device (10) according to claim 1,
wherein the two wall elements (30, 32), together with the enclosed air filter unit and/or paint mist separator unit (22), and except for an air inlet (44) and an air outlet (42), form a unit that is encapsulated on all sides.

6. The device (10) according to claim 5,
wherein the rear wall element (32) has the air outlet (42) as an opening in one of its surfaces, in particular in its major surface (62).

7. The device (10) according to claim 5,
wherein the front wall element (30), due to its shape, forms the air inlet (44).

8. The device (10) according to claim 7,
wherein the front wall element (30) is a molded part that is bent along its vertical axis in the manner of a U profile, and
wherein the front wall element (30), by means of the edges at its upper end, namely, the base and the two legs of the U profile, together with the adjoining surface section of the air filter unit and/or paint mist separator unit (22) forms the air inlet (44).

9. The device (10) according to claim 1,
wherein the two wall elements (30, 32) are molded metal parts.

10. The device (10) according to claim 1,
including an air filter unit and/or paint mist separator unit (22) that are/is encased by one of the two wall elements (30, 32).

11. A method for using a device (10) according to claim 1,
wherein a used air filter unit and/or paint mist separator unit (22) are/is removed from the device (10) by releasing the connection between the two wall elements (30, 32) and removing the air filter unit and/or paint mist separator unit (22) between the two wall elements (30, 32),
wherein a new air filter unit and/or paint mist separator unit (22) are/is placed in the device (10) by placing the new air filter unit and/or paint mist separator unit (22) between the two wall elements (30, 32) and subsequently reconnecting the two wall elements (30, 32) to one another.

12. The method according to claim 11,
wherein the used and the new air filter unit and/or paint mist separator unit (22) are each placed on a transport element, in particular a pallet (34),
wherein the used air filter unit and/or paint mist separator unit (22) between the wall elements (30, 32) are/is removed by lifting and moving their transport element by means of a transport device intended for this purpose, in particular a lift truck, forklift, or the like, and
wherein the new air filter unit and/or paint mist separator unit (22) are/is placed between the wall elements (30, 32) by moving their transport element by means of a transport device intended for this purpose, in particular a lift truck, forklift, or the like, between the wall elements (30, 32) and setting it down there.
